(19) United States
(12) Patent Application Publication
(10) Pub. No.: US 2015/0278762 A1
(43) Pub. Date: Oct. 1, 2015

(54) Computer Implemented Centralized System for Managing Animal Adoptions and a Method Thereof

(71) Applicant: JULIANNE SONTAG-PIERCE, North Attleboro, MA (US)

(72) Inventor: JULIANNE SONTAG-PIERCE, North Attleboro, MA (US)

(21) Appl. No.: 14/740,073

(22) Filed: Jun. 15, 2015

(51) Int. Cl. G06Q 10/10

(52) U.S. Cl. CPC G06Q 10/10

(57) ABSTRACT

A computer implemented system and method for managing animal shelters and animal adoptions have been disclosed. The system obviates the need for an animal welfare organization to create and maintain a computerized animal adoption application form. The system centralizes the process of animal adoption, wherein an animal adoption form (adoption questionnaire) filled by a potential adopter at a particular animal welfare organization, can be made available across a plurality of other animal welfare organizations, thereby obviating the need for the adopter to fill out individual adoption forms at respective animal welfare centers, and thereby centralizing the management of animal adoption forms.

### BACKGROUND

1. Technical Field

The present disclosure relates to animal shelter management. Particularly, the present disclosure relates to a centralized web based system capable of remotely managing the adoption schemes of a plurality of animal shelters.

2. Description of Related Art

Animal Welfare Organizations (AWO) do not typically incorporate a centralized adoption application. Further, given the humungous number of animals sheltered in animal welfare organizations and given the large volumes of adoption applications (from potential adopters), animal welfare organization always find it difficult to, inter-alia, verify the credentials of all the applicants, initiating a conversation/follow up process with each of the potential adopters. Given the aforementioned drawbacks, some potential adopters would purchase a pet animal from classified advertisements websites such as Craigslist™, or a pet store, rather than visiting an animal welfare organization.

The need of the hour is to overcome the aforementioned drawbacks and virtually integrate all the animal welfare organizations by creating a centralized infrastructure that enables animal welfare organizations to process animal adoption applications in a steadfast manner, help easily identify qualified potential adopters and derive best possible matches for the qualified adopters. Moreover, there was also felt a need for a centralized infrastructure that enables animal welfare organizations to mark potential adopters for any discrepancies, and raise notes voicing concerns about said adopters, and also share those discrepancies and corresponding notes with other animal welfare agencies in real time so that the other animal welfare agencies are also informed about potential adopters having discrepancies. Further, there was also felt a need for a centralized system that would make available a (potential) adopter's information including the animals previously adopted/surrendered.

### OBJECTS

An object of the present disclosure is to provide a system that ensures that a single adoption application is valid across all animal adoption facilitation centers.

Yet another object of the present disclosure is to provide a system that brings about a significant increase in customer satisfaction in having one centralized application being made available to all animal adoption facilitation centers.

Still a further object of the present disclosure is to provide a system that brings about a significant decrease in the man hours necessary for pre-screening veterinary references, related home visits and compliances.

One more object of the present disclosure is to provide a system that ensures that there is an increase in information sharing across all the animal adoption facilitation centers.

Another object of the present disclosure is to provide a system that enables an increased networking between animal adoption facilitation centers, in real-time.

Still a further object of the present disclosure is to provide a system that increases the turn around on animal adoptions to qualified homes, as a result of reduction in man hours spent on initial processing of adoption applications.

One more object of the present disclosure is to provide a system that is proactive in terms of deriving a best match between potential owners and animals available for adoption.

Yet another object of the present disclosure is to provide a system that enables automated tracking of information corresponding to animal adoptions, as well as trends regarding animal adoption and animal surrender, amongst other related issues.

Still a further object of the present disclosure is to provide a system that makes available an online history corresponding to each of the potential adopters.

One more object of the present disclosure is to provide a system that improves the workflow, reduces redundancy in an animal adoption facilitation center.

### SUMMARY

The present disclosure envisages a computer implemented centralized system for managing animal adoptions. The system comprises a centralized server which in turn includes a processor configured to generate an animal adoption application for eliciting information about a potential adopter. The processor is further configured to transmit the animal adoption application to a computer enabled device accessible to the potential adopter, and receive the animal adoption application filled up be the potential adopter, and analyze the information about the potential adopter provided therein.

The system further includes a repository configured to store the information about the potential adopter along with the animal adoption application filled up by the potential adopter. The repository is further configured to store information corresponding to animals available for adoptions. The system further includes at least one computer enabled device communicably coupled to said centralized server, and accessible to at least one animal adoption manager, the computer enabled device configured to receive from the repository the information about the potential adopter, and present the information to the animal adoption manager for analysis and review.

In Accordance with the present disclosure, the computer enabled device is configured to present the filled up animal adaptation application to the animal adaptation manager, for analysis and review.

In accordance with the present disclosure, the computer enabled device enables the animal adoption manager to search for the potential adopters' animal adoption application using at least one of adopter's telephone number, name and residential address.

In accordance with the present disclosure, the computer enabled device enables the animal adoption manager to mark animal adoption applications for irregularities.

The present disclosure envisages a computer implemented method for managing animal adoptions, the method comprising the following computer implemented steps:
generating using a processor, an animal adoption application for eliciting information about a potential adopter;
transmitting, using said processor, the animal adoption application to a computer enabled device accessible to the potential adopter;
receiving the animal adoption application filled up by the potential adopter, and analyzing the information about the potential adopter provided therein;
storing the information about the potential adopter along with the animal adoption application filled up by the potential adopter, in a repository;
storing information corresponding to animals available for adoptions, in said repository;
enabling at least one computer enabled device accessible to at least one animal adoption manager, to receive the information about the potential adopter;
enabling said computer enabled device to and present the information to the animal adoption manager for analysis and review.

In accordance with the present disclosure, the method further includes the step of presenting the filled up animal adaptation application to the animal adaptation manager for analysis and review, via the computer enabled device.

In accordance with the present disclosure, the method further includes the step of enabling the animal adoption manager to search for the potential adopters' animal adoption application using at least one of adopter's telephone number, name and residential address.

In accordance with the present disclosure, the method further includes the step of enabling the animal adoption manager to mark animal adoption applications for irregularities.

### BRIEF DESCRIPTION OF ACCOMPANYING DRAWINGS

The other objects, features and advantages will occur to those skilled in the art from the following description of the preferred embodiment and the accompanying drawings in which:

FIG. 1 is a block diagram illustrating the components of the computer implemented self-learning system for categorizing input text; and

FIG. 2 illustrates a flow chart describing the steps involved in the computer method for determining the sentiment conveyed by an input text.

### DETAILED DESCRIPTION

In order to overcome the drawbacks faced by the animal welfare organizations, the present disclosure envisages a computer implemented centralized system for managing animal adoptions. The system envisaged by the present disclosure obviates the need for an animal welfare organization to create and maintain a computerized animal adoption application form. The prime objective of the system envisaged by the present disclosure is to centralize the process of animal adoption, wherein an animal adoption form (adoption questionnaire) filled by a potential adopter at a particular animal welfare organization, can be made available across a plurality of other animal welfare organizations, thereby obviating the need for the adopter to fill out individual adoption forms at respective animal welfare centers, and centralizing the management of animal adoption forms. The system envisaged by the present disclosure simplifies and also streamlines the animal adoption process for both the adopter as well as the participating animal welfare organizations.

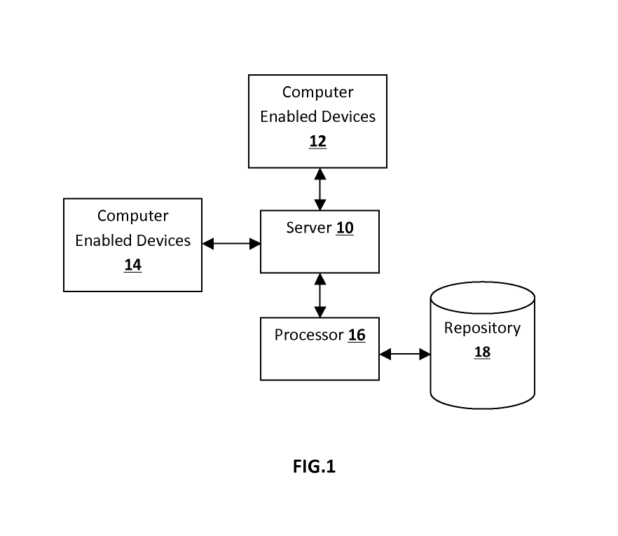

Referring to FIG. 1 there is shown a computer-implemented, centralized system 100 for managing animal adoptions. The system 100 comprises a centralized server 10 that manages animal adoptions in a centralized manner. The centralized server 10 is typically cooperates with computer enabled devices 12 accessible to potential adopters, and computer enabled devices 14 accessible to animal adoption managers associated/employed with animal welfare organizations.

In accordance with the present disclosure, the centralized server 10 further includes a processor 16 configured to generated an animal adoption application. The animal adoption application typically includes commonly asked queries. For example, frequently asked queries such as “who do you want to adopt this animal for”, “what type of home do you live in”, “do you have any other pets in your household”, are incorporated in the animal adoption application.

In accordance with the present disclosure, the animal adoption application generated (created) by the processor 16 is transmitted to the computer enabled devices 12 accessible to the potential adopters. Further, when the centralized server 10 receives the filled-up animal adoption form, back from the potential adopter, the processor 16 processes the filled-up animal adoption form, and subsequently stores the details/information provided by the potential adopter, in a repository 18.

In accordance with the present disclosure, the repository 18 is configured to store the information about the potential adopter along with the animal adoption application filled up by the potential adopter. The repository 18 is further configured to store information corresponding to animals available for adoptions.

In accordance with the present disclosure, the centralized server 10 cooperates with computer enabled devices 14 accessible to animal adoption managers associated/employed with animal welfare organizations. The processor 16, through the centralized server 10 transmits the filled up animal adoption forms of respective potential adopters to computer enabled devices 14, for review and scrutiny by animal adoption managers.

In accordance with the present disclosure, the computer enabled devices 14 enable the animal adoption manager to search for the potential adopters' animal adoption application using at least one of adopter's telephone number, name and residential address. In accordance with the present disclosure, the computer enabled devices 14 enable the animal adoption manager to mark animal adoption applications for irregularities.

In accordance with the present disclosure, the centralized server 10 generates a questionnaire/animal adoption application which incorporates typically asked animal adoption related questions. The processor 16 transmits the animal adoption application to a plurality of potential adopters having access to respective computer enabled devices collectively denoted by the reference numeral 12. The potential adopters fill-up the questionnaire, and transmit the filled up questionnaire to the centralized server 10. The processor 16 of the centralized server 10 processes the received filled-up questionnaire, and subsequently stores the information provided by the potential adopters (via the filled-up questionnaire), in a repository 18. The repository 18 is also communicably coupled to the centralized server 10.

Subsequently, the information provided by the potential adopters is stored in the repository 18, and is rendered accessible via centralized server 10. The computer enabled devices 16 accessible to animal adoption managers are configured to access the centralized server 10, and elicit from the repository 10, the information corresponding to each of the potential applicants.

The computer enabled devices 14 typically elicit information (relating to potential adopters) from the repository 10, in the form of a ‘record’ or a ‘file’. The record/file comprising information (relating to potential adopters) elicited from the repository 10, is typically scrutinized by animal adoption managers using computer enabled device(s) 14.

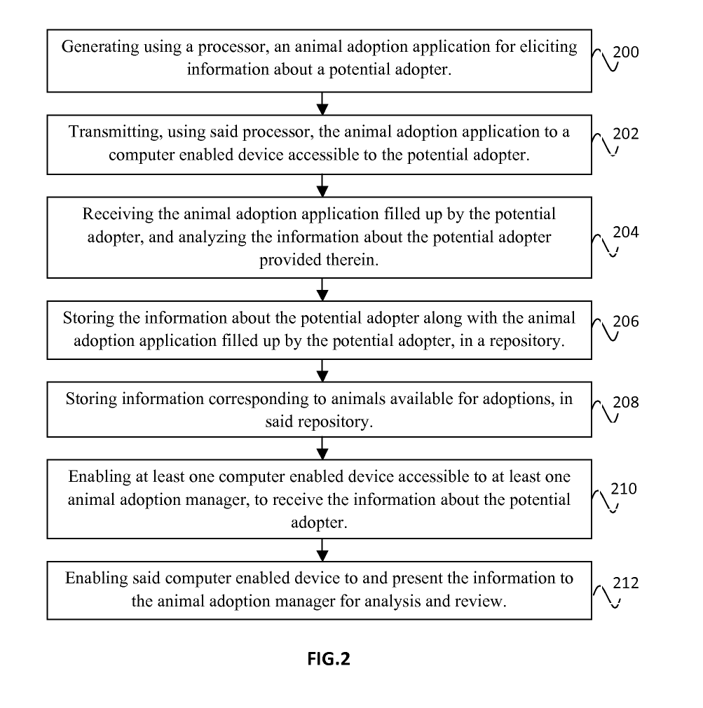

Referring to FIG. 2, there is shown a flowchart illustrating the steps involved in the computer implemented method for managing animal adoptions. The method, in accordance with the present disclosure comprises the following computer implemented steps:
generating using a processor, an animal adoption application for eliciting information about a potential adopter (200);
transmitting, using said processor, the animal adoption application to a computer enabled device accessible to the potential adopter (202);
receiving the animal adoption application filled up by the potential adopter, and analyzing the information about the potential adopter provided therein (204);
storing the information about the potential adopter along with the animal adoption application filled up by the potential adopter, in a repository (206);
storing information corresponding to animals available for adoptions, in said repository (208);
enabling at least one computer enabled device accessible to at least one animal adoption manager, to receive the information about the potential adopter (210); and
enabling said computer enabled device to and present the information to the animal adoption manager for analysis and review (212).

In accordance with the present disclosure, the method further includes the step of presenting the filled up animal adaptation application to the animal adaptation manager for analysis and review, via the computer enabled device.

In accordance with the present disclosure, the method further includes the step of enabling the animal adoption manager to search for the potential adopters' animal adoption application using at least one of adopter's telephone number, name and residential address.

In accordance with the present disclosure, the method further includes the step of enabling the animal adoption manager to mark animal adoption applications for irregularities.

### TECHNICAL ADVANTAGES

The technical advantages envisaged by the present disclosure include a realization of a system that ensures that a single adoption application is valid across all the animal adoption facilitation centers. The system envisaged by the present disclosure brings about a significant increase in customer satisfaction in having one centralized application being made available to all animal adoption facilitation centers. Further, the system brings about a significant decrease in the man hours necessary for pre-screening veterinary references, related home visits and compliances. Further, the system brings about an increase in information sharing across all the animal adoption facilitation centers. The system provides for an increased networking between animal adoption facilitation centers, in real-time. The system increases the turn around on animal adoptions to qualified homes, as a result of reduction in man hours spent on initial processing of adoption applications. The system also derives best match between potential owners and animals available for adoption. The system enables automated tracking of information corresponding to animal adoptions, as well as trends regarding animal adoption and animal surrender, amongst other related issues. The system stores and renders accessible an online history corresponding to each of the potential adopters. The system improves the workflow, reduces redundancy in an animal adoption facilitation center.

We claim:

1. A computer implemented centralized system for managing animal adoptions, said system comprising:
a centralized server comprising:
a processor configured to generate an animal adoption application for eliciting information about a potential adopter, said processor further configured to transmit the animal adoption application to a computer enabled device accessible to the potential adopter, said processor still further configured to receive the animal adoption application filled up be the potential adopter, and analyze the information about the potential adopter provided therein;
a repository configured to store the information about the potential adopter along with the animal adoption application filled up by the potential adopter, said repository further configured to store information corresponding to animals available for adoptions;
at least one computer enabled device communicably coupled to said centralized server, and accessible to at least one animal adoption manager, said computer enabled device configured to receive from the repository the information about the potential adopter, and present the information to the animal adoption manager for analysis and review.

2. The system as claimed in claim 1, wherein said computer enabled device is configured to present the filled up animal adaptation application to the animal adaptation manager, for analysis and review.

3. The system as claimed in claim 1, wherein said computer enabled device enables the animal adoption manager to search for the potential adopters' animal adoption application using at least one of adopter's telephone number, name and residential address.

4. The system as claimed in claim 1, wherein said computer enabled device enables the animal adoption manager to mark animal adoption applications for irregularities.

5. A computer implemented method for managing animal adoptions, said method comprising the following computer implemented steps:
generating using a processor, an animal adoption application for eliciting information about a potential adopter;
transmitting, using said processor, the animal adoption application to a computer enabled device accessible to the potential adopter;
receiving the animal adoption application filled up by the potential adopter, and analyzing the information about the potential adopter provided therein;
storing the information about the potential adopter along with the animal adoption application filled up by the potential adopter, in a repository;
storing information corresponding to animals available for adoptions, in said repository;
enabling at least one computer enabled device accessible to at least one animal adoption manager, to receive the information about the potential adopter;
enabling said computer enabled device to and present the information to the animal adoption manager for analysis and review.

6. The method as claimed in claim 5, wherein the method further includes the step of presenting the filled up animal adaptation application to the animal adaptation manager for analysis and review, via the computer enabled device.

7. The method as claimed in claim 5, wherein the method further includes the step of enabling the animal adoption manager to search for the potential adopters' animal adoption application using at least one of adopter's telephone number, name and residential address.

8. The method as claimed in claim 5, wherein the method further includes the step of enabling the animal adoption manager to mark animal adoption applications for irregularities.
